(19) United States
(12) Patent Application Publication
(10) Pub. No.: US 2005/0199134 A1
(43) Pub. Date: Sep. 15, 2005

(54) Electroporation reactor for continuously processing products in the form of pieces

(76) Inventors: Christoph Schultheiss, Pfinztal (DE); Martin Kern, Waghausel (DE)

Correspondence Address: Klaus J. Bach, 4407 Twin Oaks Drive, Murrysville, PA, 15668, US

(21) Appl. No.: 10/773,051

(22) Filed: Feb. 5, 2004

Related U.S. Application Data
(63) Continuation-in-part of application No. PCT/EP02/09529, filed on Aug. 27, 2002.

(30) Foreign Application Priority Data
Sep. 10, 2001 (DE) 101 44 479.6

(51) Int. Cl. A23C 3/07

(52) U.S. Cl. 99/451

(57) ABSTRACT

In an electroporation reactor for continuously processing products in the form of pieces wherein a drum with carrier elements is rotatably supported in a housing of dielectric material in a process liquid through which the products are moved from an inlet to an outlet through a degasification zone, a reaction zone and a discharge zone at the bottom of the housing, a group of electrodes is arranged adjacent the treatment zone and a high voltage is supplied to the electrodes within not more than 3 μsec generating between the electrodes and the grounded drum a large potential difference for the electroporation of all the walls of the process pieces while passing through the reaction zone.

This is a Continuation-in-Part application of International application PCT/EP02/09529 filed 27 Aug. 2002 and claiming the priority of German application 101 44 479.6 filed Oct. 9, 2001.

### BACKGROUND OF THE INVENTION

The invention relates to an electroporation reactor for the commercial continuous processing of pieces, the process goods, particularly agricultural products, such as sugar beets, potatoes, vegetables, fruits, herbs and also animal products, in a processing liquid using high voltage impulses. The agricultural products are present in the form of whole pieces as harvested, in the form of broken up pieces which can be screened or reduced in size to small pieces.

A process for decomposing the cell material by means of pulsed electric fields (high voltage discharges) is called electroporation or, respectively, electroplasmolysis.

From the literature apparatus for the treatment of plant cells or, respectively, food products that can be pumped are known, for example the following:

U.S. Pat. No. 3,766,050—“APPARATUS FOR THE TREATMENT OF FLUIDS OR SOLUTIONS BY ELECTRIC FIELDS”; 1973-10-16. Herein reactor designs with differently arranged electrodes and differently dimensioned flow channels are described. The reactors can be used exclusively for processing small amounts and small particle sizes.

U.S. Pat. No. 4,723,483—“ELECTROPLAMOLYZER FOR PROCESSING VEGETABLE STOCK”; 1998-02-09 or FR 2 619 489 “ELECTOPLASMALYSER FOR PROCESSING VEGETABLE MATERIALS”; 1989-02-24. In these documents, a round or respectively rectangular reactor cross-section is described wherein pairs of electrodes are installed in different arrangements. The product is transported through the reactor by gravity or pump pressure.

U.S. Pat. No. 5,031,521 “ELECTROPLASMOLYZER FOR PROCESSING PLANT RAW MATERIAL”; 1991-07-16. Herein, a reactor geometry similar to that of U.S. Pat. No. 4,723,482 is described; the electric energy is applied however by electromagnets.

U.S. Pat. No. 5,186,800—ELECTROPORATION OF PROKARYOTIC CELLS”; 1993-12-16. Herein, very small laboratory reactors are described, in which small products are treated batch-wise by voltage impulses. The reactors have no moving parts.

U.S. Pat. No. 5,549,041—“BATCH MODE FOOD TREATMENT USING PULSED ELECTRIC FIELDS”, 1996-08-27. This publication describes small reactors with areal electrodes between which suspensions are pumped for treatment.

The process of electroporation is employed for the extraction of intracellular substances. To this end, the valuable materials are usually pressed out or gathered by extraction procedures. The treatment with pulsed electric fields occurs in a processing liquid which is generally water with a low conductivity.

Known apparatus (reactors) may be used for food stuff that can be pumped and for suspensions.

If also products in the form of pieces with 20-30 sorts of element and a piece weight of 1-5 kg are to be treated, such products cannot be transported through the known reactors.

The industrial treatment of products such as agricultural products by high voltage impulses requires, in comparison with the known apparatus for electroporation, a high continuous mass flow with a pulsed electric field which is effective on the product as uniformly as possible.

The difficulties encountered in the process and the disadvantages of the state of the art are as follows:

Product Through-Put

For the agricultural products to be treated in the apparatus often a high throughput per hour is needed (for example, in sugar processing 600 Mg beets/hr). The apparatus must provide for a high throughput with very little damage to the product.

Product Transport

Between the product to be treated and the liquid required for the pulse treatment, there is only a small difference in density. As a result, there is a slow settling speed so that, with natural gravitational feeding of the product only insufficient product through puts can be achieved.

Clogging Problems

Based on the different geometric shapes of the agricultural products to be treated, there is a high sensitivity to blockages and bridge formation.

Reactor Geometry, Clogging

Based on the high-electric field strength (electro-pulsing) required for limiting the energy consumption, the reactor diameters must be relatively small even with high pulse voltages. Small reactor diameters have a high clogging tendency.

Product Loss

To avoid product losses (pre-extraction) and for limiting the accumulation of electrolytes in the operating liquid, it is expedient to treat the products in an undamaged form (whole beets, apples, tomatoes, cucumbers, etc.), but this is not absolutely necessary.

Product Treatment

Particularly in connection with fruits, floating of the products can be observed. Under these circumstances, a sufficient exposure to voltage impulses cannot be achieved.

Effect of the Electric Field

For optimizing the necessary energy input, the product must move relative to the pulsed electric field. Therefore a continuous transport is required.

Consequently, it is the object of the present invention to provide an apparatus in which high mass flows, for example 600 Mg/h, can be generated with relatively small transport cross-sections and the flow extends through an electric field, which is pulsed periodically or in predetermined time intervals.

### SUMMARY OF THE INVENTION

In an electroporation reactor for continuously processing products in the form of pieces wherein a drum with carrier elements is rotatably supported in a housing of dielectric material in a process liquid through which the products are moved from an inlet to an outlet through a degasification zone, a reaction zone and a discharge zone at the bottom of the housing, a group of electrodes is arranged adjacent the treatment zone and a high voltage is supplied to the electrodes within not more than 3 μsec generating between the electrodes and the grounded drum a large potential difference for the electroporation of all the walls of the process pieces while passing through the reaction zone.

In combination with a suitable impulse generators such as a condenser bank with a controlled switch or a switch operating in a break down mode, that is a Marx-generator, the cells can be crushed in quantity processing non-thermally by irreversible perforation of the cell membranes of vegetative cells with relatively low specific energy requirements.

Such an electroporation reactor consists of: a cylindrical drum, which is electrically insulated or consists of a dielectric material, and which is supported horizontally and rotatably about its cylinder or rotational axis. At its outer surface, the drum is provided with carrier elements, which are distributed over the circumference of the drum. The carrier members extend parallel to the rotational axis of the drum and project radially outwardly. A double wall chamber of a dielectric material surrounds with its inner wall the drum with the carrier elements in a contact-free and equidistant manner up to an open area above the axis of rotation of the drum. At the open area of the chamber, a feeding device is connected to the inner wall of the chamber at the upper edge of the open area. In the lower area of the month of the feeding device, an admission rake is installed through which the carrier elements of the drum move. A discharge chute extends from the inner wall of the lower open area of the chamber. A discharge rake through which the carrier elements of the drum move upon surfacing from the process liquid collects the goods which have meanwhile been electrically processed and directs it onto the discharge chute for further transport. In the lowermost area of the reaction chamber, an electrode structure is installed which is exposed toward the drum and includes at least one electrode, which extends at most over the height of the drum. The electrode is connected by way of a high voltage switch, which is controlled or operated by collapse, to an external electrical energy storage device which can be connected sufficiently rapidly to the electrode structure. Within predetermined adjustable time periods a high electrical potential is applied to the electrode group whereby toward the potential electrodes mounted and the drum which is grounded by way of the drum shaft, a highly homogenous electrical field is established which is always so strong that the goods carried along in the processing liquid are electroporated.

In an operational apparatus, the area of each electrode group, which his exposed toward the drum is always fully wetted by the process liquid. Also, each electrode group is connected to its own electrical energy storage device by way of its own switch. Such an energy storage device is generally a condenser which can be rapidly discharged in order to generate the electric field or, respectively, voltage increase in the reaction areas sufficiently rapidly. For this purpose, Marx generators, for example, are very suitable.

Further features which, on one hand, are expedient and, on the other hand, provide for a good long-term operation, are:

It is necessary to transport the process goods by force at low rotational speed and vent the area where the good is being submerged (degasification zone). In the high voltage treatment area (reaction zone), the electric field established during exposure to the electric pulses experiences different orientations by the relative movements of the electrons which substantially improves the treatment results.

During operation, the level of the operating liquid is always between the rotational axis of the drum and the highest pulse electrodes or electrode groups. The area of immersion into the operating liquid extends to a depth of at least twice the distance between the potential and the pulse electrodes in order to release all the air bubbles from the mixture of the goods being processed and to keep the process liquid exposed to the electrodes.

The whole apparatus is electromagnetically shielded toward the environment in order to prevent disturbances to the surrounding apparatus and equipment.

Below, the invention will be described in its functioning and its construction in greater detail on the basis of the accompanying drawings. The drawing comprises FIGS. 1 to 3. They show specifically:

### BRIEF DESCRIPTION OF THE DRAWINGS

FIG. 1 is a sectional side view of the electroporation reactor,

FIG. 2 shows an axial cross-section through the electroporation reactor, and

FIG. 3 shows a development of the wall area of the reaction chamber with the arrangement of electrodes.

### DESCRIPTION OF A PARTICULAR EMBODIMENT

Below, as an example, the treatment of beets is described:

The washed beets are supplied, by way of the admission rake, to the inlet zone a of the electroporation reactor and are deposited in the transport chamber. The transport chamber on the annular space including the reaction zone is formed between the drum 7, which in the present case has a dielectric coating, and the outer delimitation of the reaction chamber 12.

Upon rotation of the drum by the drive unit 4, the carrier elements 5 move the beets from the supply rake 6 and carry them along into the annular transport space between the drum 7 and the outer reaction chamber delimitation 12. The beets, which are first still dry, are immersed after ¼ turn of the drum 7 into the process liquid of the electroporation reactor which in this case is water. The immersion area forms the degasification zone b. In this zone, air bubbles adhering to the beets are removed by suitable measures such as water jets, vibration or other suitable measures. This is important since, upon breakdown of the high voltage and arcing through the reaction chamber, shock waves develop on the gas bubbles which detrimentally affect the operation of the reactor over an extended period and which may even destroy the reactor.

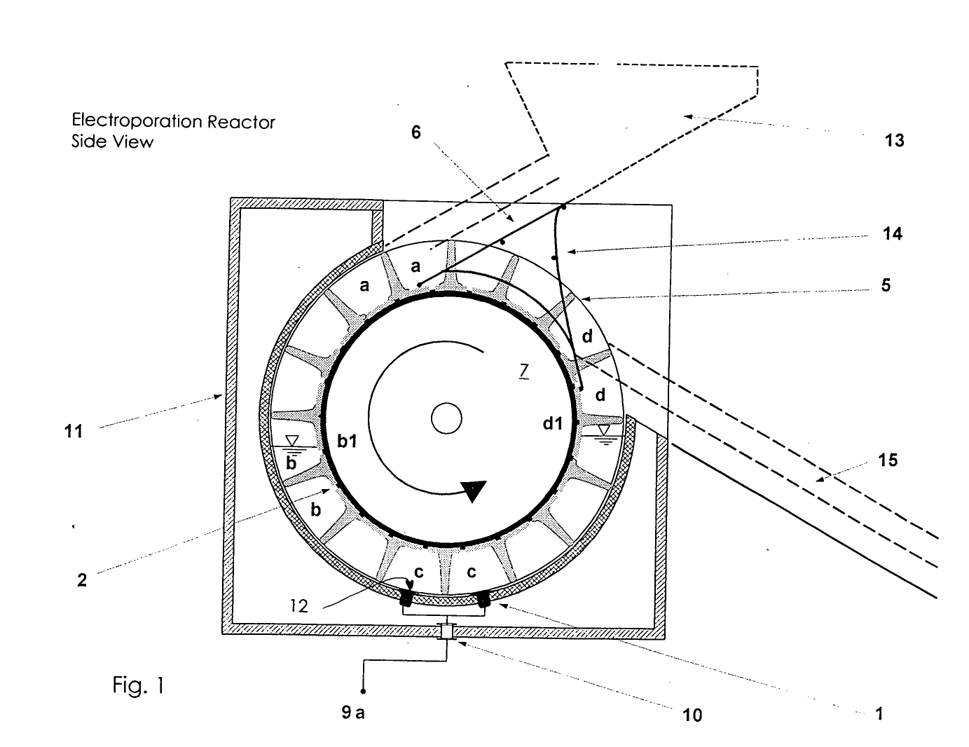

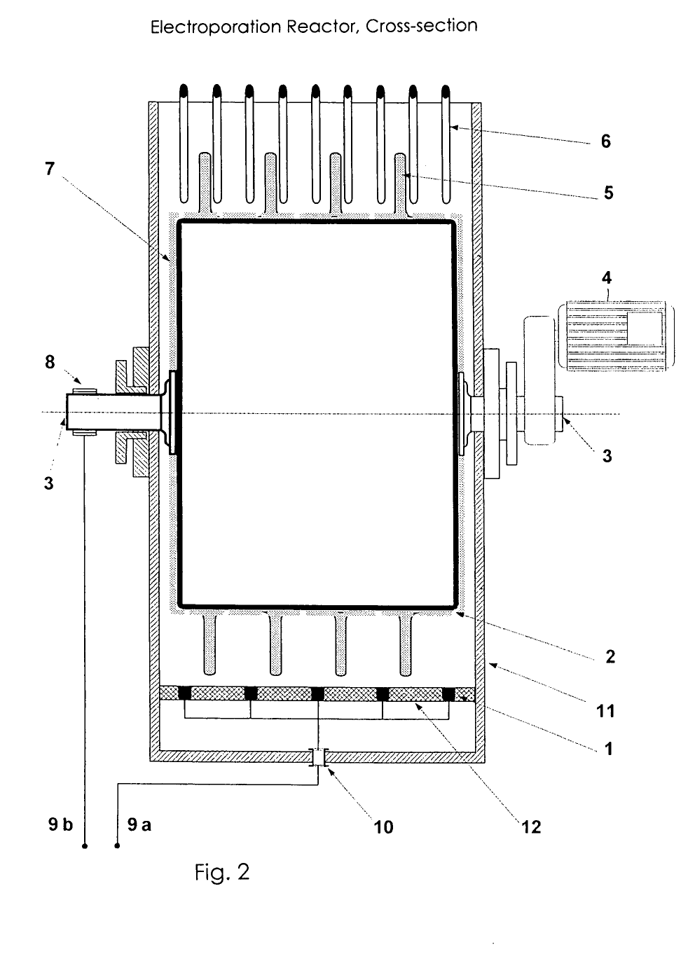

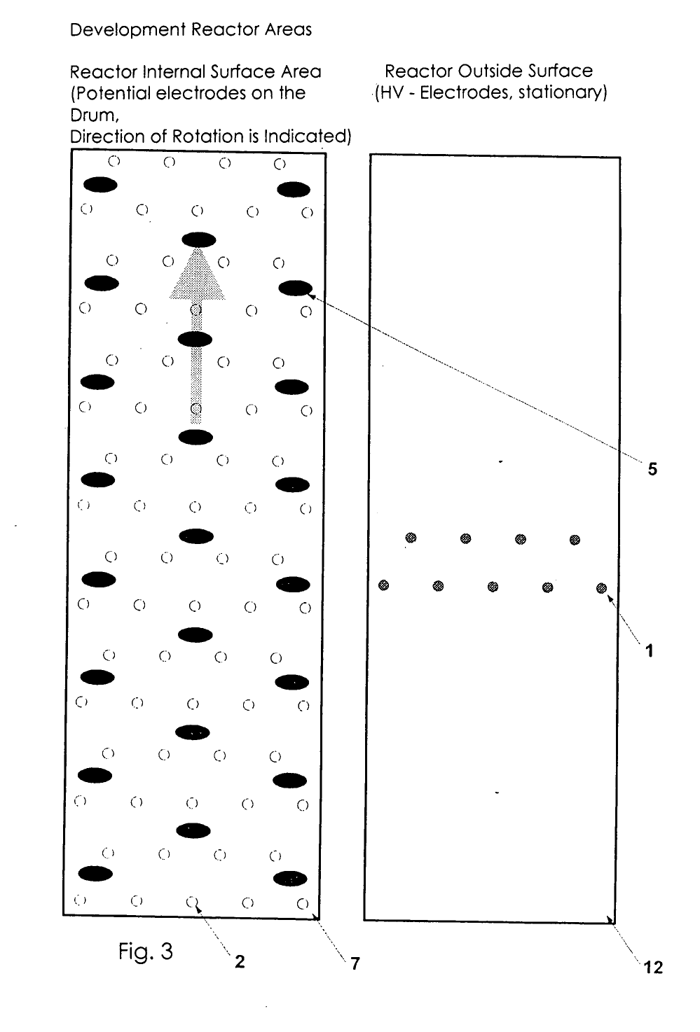

Upon immersion into the water pool and the degasification, the beets are transported successively into the reaction zone C. As shown in FIG. 1, there are two reaction zones c, but it may be only one or also more than two. The pulse voltage which in this case may be up to several 100 kV, is coupled into the water by way of the metallic electrodes 1. The electrodes 1, to which a high voltage is supplied, are installed in the high voltage insulating wall of the chamber 12 so as to be flat with the chamber wall (see FIGS. 1, 2 and 3). The counter electrode 2, which is needed for the high voltage discharge and which represents the reference or ground potential is provided by the outer surface of the drum 7, that is by the blank metal surface thereof facing the annular space (see the development of FIG. 3). With the angular displacement of the pulse electrodes 1, the electric field also has different orientations.

Upon further rotation of the transport chambers, the carrier elements 5 lift the processed beets out of the water bath. They are then removed from the transport chambers bye the discharge rake 14. In the process, the water can drip from the processed beets and the beet material is moved by way of the discharge chute 15 on to further processing.

The carrier elements 5, the reactor housing 11 in the area of the reaction chamber, the dielectric isolation layer of the drum 7 and the high voltage insulation of the pulse electrodes 12 consist of an electrically insulating material such as polyethylene nature, polyethylene black, polypropylene gray, polyurethane PU and reinforced or, respectively, glass fiber reinforced materials or they are insulated by such materials.

Form and surface of the carrier elements 5 are optimized in such a way that they have the necessary mechanical strength and that high voltage discharges along the carrier elements are prevented.

For the suppression of electromagnetic radiation reaching the environment, the apparatus is adequately shielded for example by metal shielding.

Since the axis of rotation, that is, the shaft 3 of the drum 7, is disposed above the liquid level sealing problems which cannot easily be controlled and resulting electrical insulation problems are avoided.

1. An electroporation reactor for the continuous processing of products in the form of pieces, such as in a process liquid using high voltage pulses, said reactor comprising a housing (11) of dielectric material, a circular cylindrical metallic drum (7) supported in said housing so as to be capable of rotating about its horizontal cylinder axis at 0.5 to 4 turns per min,
carrier elements (5) disposed on the outer wall of said drum (7) and being uniformly distributed over the circumference thereof,
said housing having an open area above the axis of rotation (3) of said drum,
a process good supply structure (13) connected to said housing and having a lower area with a supply rake (6), which is disposed in a supply zone (a) of the electroporation reactor and through which the carrier elements of the drum (7) pass,
a degasification zone (b), and a reaction zone (c) formed in the space between the drum (7) and the reactor wall (12) of the housing (11), and a discharge zone (d) through which the carrier elements (5) pass, said discharge zone including a discharge rake (14) through which the carrier elements pass to collect the processed products carried along by the transport elements and to direct them onto a discharge chute (15) extending from the discharge zone (d),
at least one electrode group (1), which is disposed in the lowest arc area of the reactor wall (12) and has an exposed area which faces the drum (7) and is always fully wetted by the process liquid, each electrode group being connected to its own electrical energy supply device by way of its own switch, and grounded areas on said drum facing the annular space, so as to be capable of providing in the annular space of the electrode group to which high voltage is to be supplied, within no more than 3 μsec, an electric field strength of 10 kV/cm so that the products carried through the reaction zone reach, at least once during their passage, the threshold potential difference
Δφ=z·E=10 V
for irreversible electroporation,
the process liquid fill level in the annular space being below the rotational axis (3) of the drum and above the highest electrode group.

2. An electroporation reactor according to claim 1, wherein the carrier elements (5) mounted on the drum (7) have a coating of a dielectric material, are bend-resistant and have a wear resistant surface and are inert with respect to the process environment.

3. An electroporation reactor according to claim 2, wherein the bend-resistant carrier elements (3) mounted on the drum are resiliently supported.

4. An electroporation reactor according to claim 1, wherein said housing is a metallic housing which provides an outward magnetic radiation seal.
